(19) United States
(12) Patent Application Publication
(10) Pub. No.: US 2016/0070647 A1
(43) Pub. Date: Mar. 10, 2016

(54) MEMORY SYSTEM

(71) Applicant: Kabushiki Kaisha Toshiba, Tokyo (JP)

(72) Inventors: Chihoko Shigeta, Kunitachi Tokyo (JP); Yoshihisa Kojima, Kawasaki Kanagawa (JP)

(21) Appl. No.: 14/592,563

(22) Filed: Jan. 8, 2015

Related U.S. Application Data
(60) Provisional application No. 62/047,925, filed on Sep. 9, 2014.

(51) Int. Cl. G06F 12/08

(52) U.S. Cl. CPC G06F 12/0862; G06F 2212/1024; G06F 2212/202; G06F 2212/6022

(57) ABSTRACT

According to one embodiment, a memory system includes a non-volatile memory, a read control unit, a read-ahead unit, a buffer memory, and a resource management unit. The read control unit is configured to perform a sequential read of two threads from the non-volatile memory. The read-ahead unit is configured to perform read-ahead to the non-volatile memory for each thread. The buffer memory is configured to include two read-ahead buffers. The respective read-ahead buffers hold data which is read-ahead from the non-volatile memory. The data held by the respective read-ahead buffers belong to threads different from each other. The resource management unit is configured to obtain a peak request amount from outside for each thread and adjust a size of each read-ahead buffer based on the obtained peak request amount for each thread.

### CROSS-REFERENCE TO RELATED APPLICATIONS

This application is based upon and claims the benefit of priority from U.S. Provisional Patent Application No. 62/047,925, filed on Sep. 9, 2014; the entire contents of which are incorporated herein by reference.

### FIELD

Embodiments described herein relate generally to a memory system.

### BACKGROUND

In recent years, a memory system having a non-volatile memory mounted therein has been known. The memory system internally performs a read-ahead in order to improve a read performance for sequential reading. Data of a predetermined size is read-ahead from a location of which a logical address follows a logical address of a location of the data most recently requested from the host. The read data by the read-ahead is stored in the internal buffer. By applying the read-ahead, latency of the next read request is decreased.

### BRIEF DESCRIPTION OF THE DRAWINGS

FIG. 1 is a diagram of an exemplary configuration of a memory system of a first embodiment;

FIG. 2 is a diagram of a memory structure of a read-ahead buffer region;

FIG. 3 is a flowchart for explaining an operation of the memory system at the time of receiving a read command;

FIG. 4 is a flowchart for explaining a read-ahead;

FIG. 5 is a flowchart for explaining an operation of the first embodiment of a resource management unit;

FIG. 6 is a flowchart for explaining an operation of an access management unit;

FIG. 7 is a flowchart for explaining an operation of a second embodiment of the resource management unit;

FIG. 8 is a flowchart for explaining an operation of a third embodiment of the resource management unit; and

FIG. 9 is a diagram of an exemplary implementation of a memory system.

### DETAILED DESCRIPTION

In general, according to one embodiment, a memory system includes a non-volatile memory, a read control unit, a read-ahead unit, a buffer memory, and a resource management unit. The read control unit is configured to perform a sequential read of two threads from the non-volatile memory. The read-ahead unit is configured to perform read-ahead to the non-volatile memory for each thread. The buffer memory is configured to include two read-ahead buffers. The respective read-ahead buffers hold data which is read-ahead from the non-volatile memory. The data held by the respective read-ahead buffers belong to threads different from each other. The resource management unit is configured to obtain a peak request amount from outside for each thread and adjust a size of each read-ahead buffer based on the obtained peak request amount for each thread.

Exemplary embodiments of a memory system will be explained below in detail with reference to the accompanying drawings. The present invention is not limited to the following embodiments.

### First Embodiment

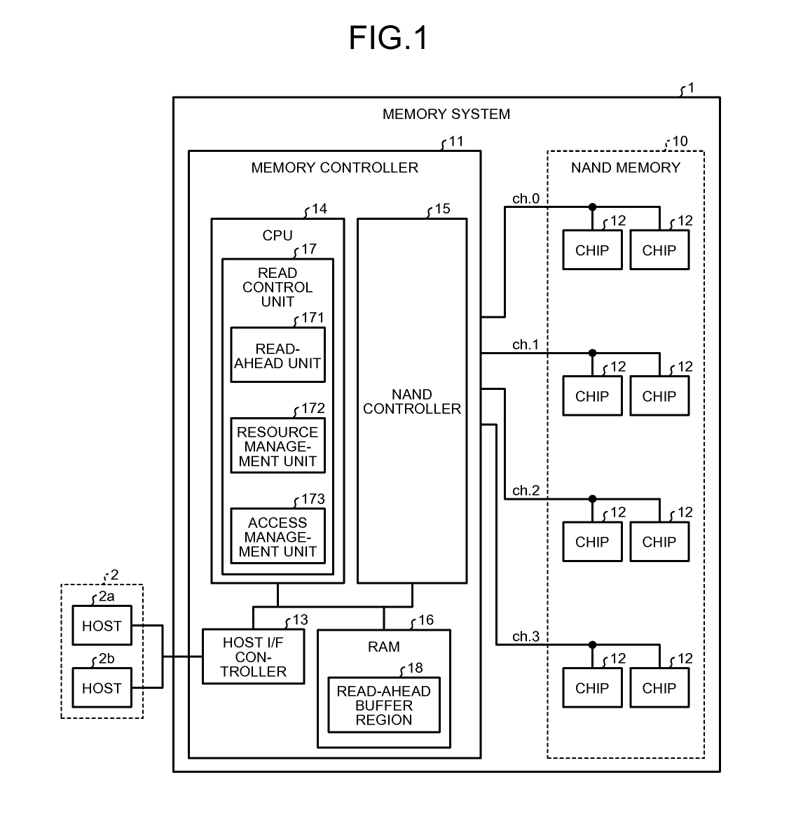

FIG. 1 is a diagram of an exemplary configuration of a memory system of a first embodiment. A memory system 1 is connected to two hosts 2 (host 2a and host 2b in FIG. 1) with a predetermined communication interface. The hosts 2a and 2b are collectively called and expressed as the “host 2”. The host 2 corresponds to, for example, a personal computer, a server computer, or a central processing unit (CPU). The memory system 1 can receive an access command (a read command, a write command, and the like) from the host 2. The access command includes logical address information indicating a head of an access destination (logical address) and size information. A logical address range of the access destination is specified by the logical address and the size information.

The memory system 1 includes a NAND-type flash memory (NAND memory) 10 and a memory controller 11 for performing data transfer between the host 2 and the NAND memory 10. The memory system 1 can include an arbitrary non-volatile memory instead of the NAND memory 10. For example, the memory system 1 can include an NOR-type flash memory instead of the NAND memory 10.

The NAND memory 10 includes a plurality of memory chips (chip) 12. In this example, the NAND memory 10 includes eight chips 12. Each chip 12 includes a memory cell array (not shown). Each memory cell array includes a plurality of blocks each of which is a unit of data erasure. Each block includes a plurality of pages each of which is a unit of data program and data read to the memory cell array. The data which has a page size and is read from the memory cell array is temporarily held by a buffer in the chip 12. After that, the data is output to the outside of the chip 12. The data which has the page size and is held by the buffer in the chip 12 is extracted by the memory controller 11 for each cluster. The size of one cluster is smaller than one page. An operation for reading the data of the page size from the memory cell array to the buffer in the chip 12 is expressed as “page read”.

The memory controller 11 includes four channels (ch.0 to ch.3). Each channel connects to two chips 12 out of eight chips 12. Each channel includes a control signal line, an I/O signal line, a chip enable (CE) signal line, a RY/BY signal line. The I/O signal line transmits/receives data, an address, and a command. A write enable (WE) signal line, a read enable (RE) signal line, a command latch enable (CLE) signal line, an address latch enable (ALE) signal line, a write protect (WP) signal line, and the like are collectively called as the “control signal line”. The respective channels are independent from each other, and the memory controller 11 can independently use each channel. The memory controller 11 can concurrently gain access to the four chips 12 having different channels at most by controlling the plurality of channels in parallel.

The memory controller 11 includes a host interface controller (host I/F controller) 13, a CPU 14, a NAND controller 15, and a random access memory (RAM) 16.

The CPU 14 controls the whole memory controller 11 based on a firmware. Especially, the CPU 14 functions as a read control unit 17 which performs the data transfer of the data, which is required according to the read command from the host 2, from the NAND memory 10 to the host 2. In addition, the read control unit 17 includes a read-ahead unit 171, a resource management unit 172, and an access management unit 173. Each function configuration unit included in the read control unit 17 will be described below.

The host I/F controller 13 controls the communication interface between the memory system 1 and the host 2. Also, the host I/F controller 13 performs the data transfer between the host 2 and the RAM 16 under the control by the CPU 14. The NAND controller 15 performs the data transfer between the NAND memory 10 and the RAM 16 under the control by the CPU 14.

The RAM 16 is a memory for providing a region where calculation data by the CPU 14 is temporarily stored, a buffer region for performing the data transfer between the host 2 and the NAND memory 10, or a storage region of management data necessary for controlling the memory controller 11. The management data includes, for example, translation information in which a correspondence relation between the logical address and a physical address is described. The physical address indicates a physical location in the NAND memory 10. The CPU 14 can translate the logical address into the physical address by referring to the translation information. The CPU 14 updates the translation information at the time of a write to the NAND memory 10. The translation from the logical address into the physical address will be expressed below as an “address resolution”.

A dynamic random access memory (DRAM) or a static random access memory (SRAM) can be applied as the RAM 16. Also, an arbitrary volatile or non-volatile memory having a higher speed than that of the NAND memory 10 can be applied instead of the RAM 16.

Also, the RAM 16 includes a read-ahead buffer region 18 which is a buffer for the read-ahead other than the above regions. The memory system 1 may receive a series of read commands corresponding an access pattern of the sequential read. The sequential read is an access pattern for sequentially reading the data in order of the logical address. Two read commands, which configure the sequential read, sequentially issued respectively specify the logical address ranges. The logical address ranges may be adjacent to each other. An offset of equal to or lower than a predetermined value may exist between the logical address ranges respectively specified by the two read commands. Here, as an example, the two read commands, which configure the sequential read, sequentially issued respectively specify the logical address ranges. The description will be made under an assumption that the logical address ranges are adjacent to each other. When receiving the read command corresponding to the access pattern of the sequential read, the read control unit 17 performs the read from the logical address range specified by the read command as a read location. At the same time, the read-ahead unit 171 starts the read from the other logical address range which follows the logical address range specified by the read command as the read location. The read-ahead is processing of previously performing the read from the other logical address range in response to the reception of the read command. The logical address range specified by the read command and the other logical address range may be adjacent to each other, and an offset which is smaller than a predetermined value may exist therebetween. Here, an example will be described under an assumption that the logical address range specified by the read command and the other logical address range are adjacent to each other. The read command corresponding to the access pattern of the sequential read is expressed as a “sequential read command”.

The read-ahead unit 171 buffers the data read according to the read-ahead to the read-ahead buffer region 18. When receiving the sequential read command at the next time, the read control unit 17 can output the data which has been previously read in the read-ahead buffer region 18. After outputting the data, the read control unit 17 removes the data from the read-ahead buffer region 18. Since the read control unit 17 can output the data from the RAM 16 not the NAND memory 10 after the reception of the sequential read command, a latency of the sequential read command can be reduced. The RAM 16 has the faster read access than that of the NAND memory 10. Data which is read in the read-ahead buffer region 18 according to the read-ahead and which has not been required to read by the read command from the host 2 yet will be expressed below as “read-ahead data”.

The read control unit 17 can manage the sequential read of the plurality of threads. The thread is a combination of a plurality of read commands which is sequentially issued so that the logical address ranges specified by the respective read commands are in succession. When the read control unit 17 receives a new read command, the read control unit 17 can identify that to which thread the new read command belongs among the plurality of threads. Any method for identifying can be applied. Here, as an example, the read control unit 17 determines which one of the logical address ranges specified by the last read commands of the respective threads is adjacent to the logical address range specified by the new read command. When the logical address range specified by the new read command is adjacent to one of the logical address ranges specified by the last read commands of the respective threads, the read control unit 17 determines that the new read command belongs to the thread.

Here, in order to simplify the description, it is assumed that each host 2 performs the sequential read of a single thread. That is, the read control unit 17 manages two threads, i.e., a thread regarding the host 2a (referred to as a thread a below) and a thread regarding the host 2b (referred to as a thread b below). Each host 2 may perform the sequential read of an arbitrary number of threads.

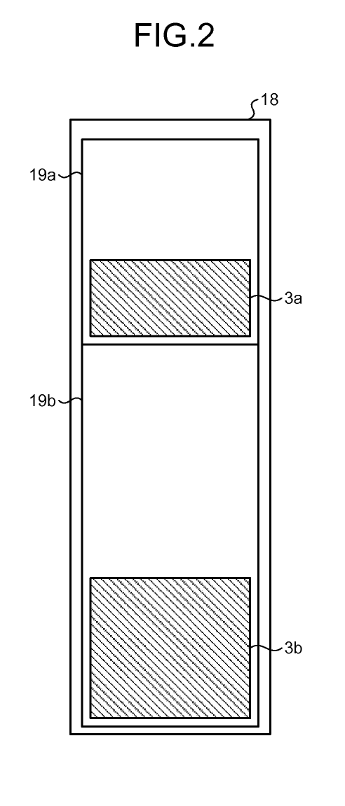

FIG. 2 is a diagram of a memory structure of the read-ahead buffer region 18. Two read-ahead buffers (a read-ahead buffer 19a and a read-ahead buffer 19b) are allocated in the read-ahead buffer region 18. The read-ahead buffer 19a buffers read-ahead data 3a of the thread a. The read-ahead buffer 19b buffers read-ahead data 3b of the thread b. The read-ahead buffers 19a and 19b are collectively expressed as a “read-ahead buffer 19”. The read-ahead buffer region 18 includes the read-ahead buffer 19 for each thread. The resource management unit 172 adjusts allocation of a memory resource in the read-ahead buffer region 18 for each read-ahead buffer 19.

As a method for adding a new read-ahead buffer 19 to the read-ahead buffer region 18 and a method for removing the existing read-ahead buffer 19, an any method can be applied. It will be assumed below that the above-mentioned two read-ahead buffers 19a and 19b be generated in the read-ahead buffer region 18. To add and remove the read-ahead buffer 19 will not be mentioned.

The resource management unit 172 adjusts the allocation of the memory resource in the read-ahead buffer region 18 for each read-ahead buffer 19. That is, the resource management unit 172 adjusts the size of each read-ahead buffer 19.

The read-ahead unit 171 supplies the read-ahead data to each read-ahead buffer 19 until each read-ahead buffer 19 becomes full. When both the read-ahead buffers 19a and 19b are not full, the read-ahead unit 171 alternately supplies the read-ahead data to the read-ahead buffers 19a and 19b. A priority for the switch is respectively set relative to the plurality of threads during the read-ahead. The read-ahead unit 171 performs the read-ahead regarding a thread with higher priority prior to the read-ahead regarding a thread with low priority.

For example, the read-ahead unit 171 makes the NAND memory 10 output data by the unit of a cluster. Processing to read a single cluster from the NAND memory 10 is expressed as a “cluster read”. The read-ahead unit 171 more frequently performs the cluster read for the read-ahead of the thread with high priority than the cluster read for reading the read-ahead data regarding the thread with low priority. Accordingly, a supply speed of the read-ahead data regarding the thread with the high priority becomes faster than that of the read-ahead data regarding the thread with the low priority.

A switching method according to the priority is not limited to the above-mentioned method. For example, the read-ahead unit 171 switches the performance of the read-ahead regarding each thread by a time slicing method. The read-ahead unit 171 allocates longer time relative to the performance of the read-ahead regarding the thread with the high priority than that of the read-ahead regarding the thread with the low priority.

In the first embodiment, the resource management unit 172 adjusts the priorities set to the threads a and b based on free space sizes of the read-ahead buffers 19a and 19b.

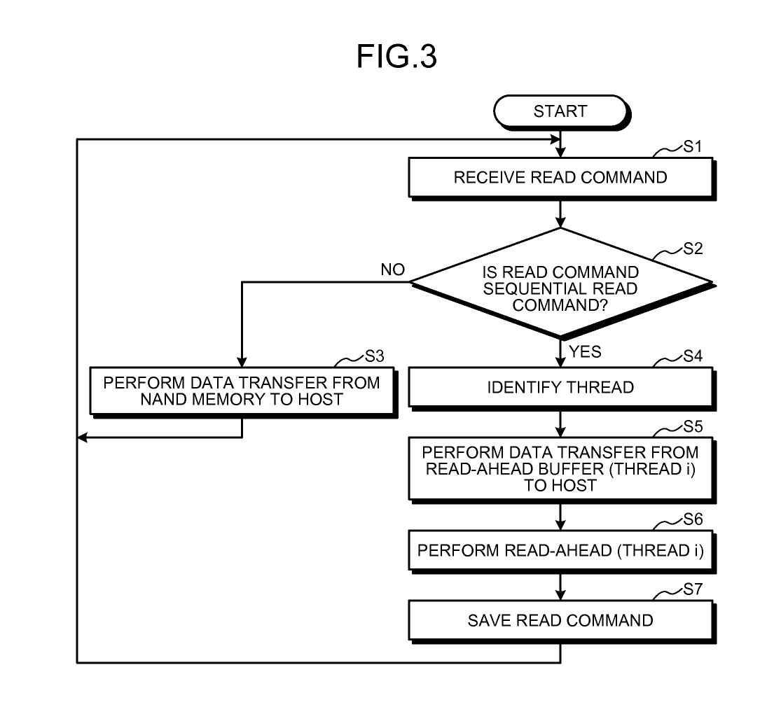

FIG. 3 is a flowchart for explaining an operation of the memory system 1 at the time of receiving the read command. When the read control unit 17 receives the read command (S1), the read control unit 17 determines whether the received read command is the sequential read command (S2). For example, when the logical address range specified by the received read command follows the logical address range specified by one of the threads, the read control unit 17 determines that the received read command is the sequential read command. Also, when the logical address range specified by the received read command does not follow the logical address range specified by any one of the threads, the read control unit 17 determines that the received read command is not the sequential read command.

When the received read command is not the sequential read command (No in S2), the read control unit 17 performs the data transfer from the NAND memory 10 to the host 2 (S3). The physical address indicating a read location in the NAND memory 10 can be obtained by performing the address resolution relative to the logical address range specified by the read command. After the processing of S3, the read control unit 17 terminates the operation.

When the read command is the sequential read command (Yes in S2), the read control unit 17 identifies the thread to which the sequential read command belongs (S4). The identified thread is expressed as a “thread i”. The reference i is a or b.

Subsequently, the read control unit 17 transfers the data, which is stored in the logical address range specified by the received read command among the read-ahead data previously buffered in the read-ahead buffer 19 for the thread i, to the host 2 (S5). The read-ahead unit 171 starts the read-ahead regarding the thread i (S6). The read-ahead is performed until the read-ahead buffer 19 for the thread i becomes full. The read control unit 17 saves the read command as the sequential read command regarding the thread i after the read-ahead has been started (S7), and then, terminates the operation. In the processing of S7, for example, the read control unit 17 saves the logical address range specified by the received sequential read command. The read control unit 17 refers to the saved logical address range, at the time of determination processing of S2 at the next time.

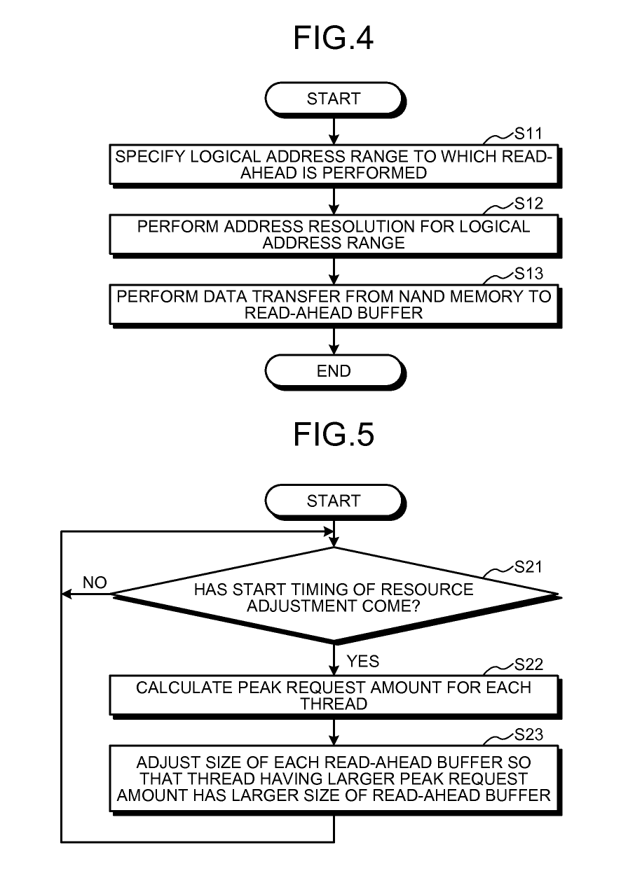

FIG. 4 is a flowchart for explaining the read-ahead regarding the thread i. First, the read-ahead unit 171 identifies a logical address range to which the read-ahead is performed (S11). The read-ahead unit 171 specifies the logical address range as the logical address range to be read-ahead. The logical address range is next to the logical address range in which the read-ahead regarding the thread i has already been performed and has a size equal to the free space size of the read-ahead buffer 19 for the thread i. The read-ahead unit 171 performs the address resolution relative to the logical address range to which the read-ahead is performed (S12). The read-ahead unit 171 sets the physical address obtained by the address resolution as the read location in the NAND memory 10 and performs the data transfer from the NAND memory 10 to the read-ahead buffer 19 for the thread i (S13). The read-ahead unit 171 terminates the read-ahead when the read-ahead buffer 19 for the thread i becomes full.

FIG. 5 is a flowchart for explaining an operation of the resource management unit 172. The resource management unit 172 determines whether a start timing of resource adjustment has come (S21). The start timing of the resource adjustment can be arbitrarily set. For example, the resource adjustment may start at predetermined time intervals. Also, the resource adjustment may start at every time when a predetermined number of commands are received.

When the start timing of the resource adjustment has not come (No in S21), the resource management unit 172 performs the processing of S21 again. When the start timing of the resource adjustment has come (Yes in S21), the resource management unit 172 calculates a peak request amount from the host 2 for each thread (S22). For example, the peak request amount is the largest value among instantaneous values of the size to which the transfer to the host 2 is required by the read command.

For example, the peak request amount is calculated as follows. The resource management unit 172 records a total amount of the size in which the read is required in a period of a first time at intervals of the first time. Each total amount can be obtained by adding the size information included in one or more read commands received in the period of the first time. The resource management unit 172 selects the maximum value in the period of the latest second time from among the respective recorded total amounts as the peak request amount. The second time is longer than the first time.

Also, the peak request amount can be simply calculated as follows. The resource management unit 172 refers to a predetermined number of read commands which has been recently received and selects the size information having the largest value as the peak request amount.

An index which is used by the resource management unit 172 as the peak request amount is not limited to the above-mentioned two examples.

After the processing of S22, the resource management unit 172 adjusts the size of each read-ahead buffer so that the thread having a larger peak request amount has a larger size of the read-ahead buffer 19 (S23). For example, when the peak request amount regarding the thread a is larger than that regarding the thread b, the resource management unit 172 adjusts the size of each read-ahead buffer 19 so that the size of the read-ahead buffer 19a becomes larger than that of the read-ahead buffer 19b. A ratio or difference between the size of the read-ahead buffer 19a and that of the read-ahead buffer 19b may be fixed or may be variably set according to a ratio or difference between the peak request amounts of the threads.

After the processing of S23, the resource management unit 172 performs the processing of S21 again.

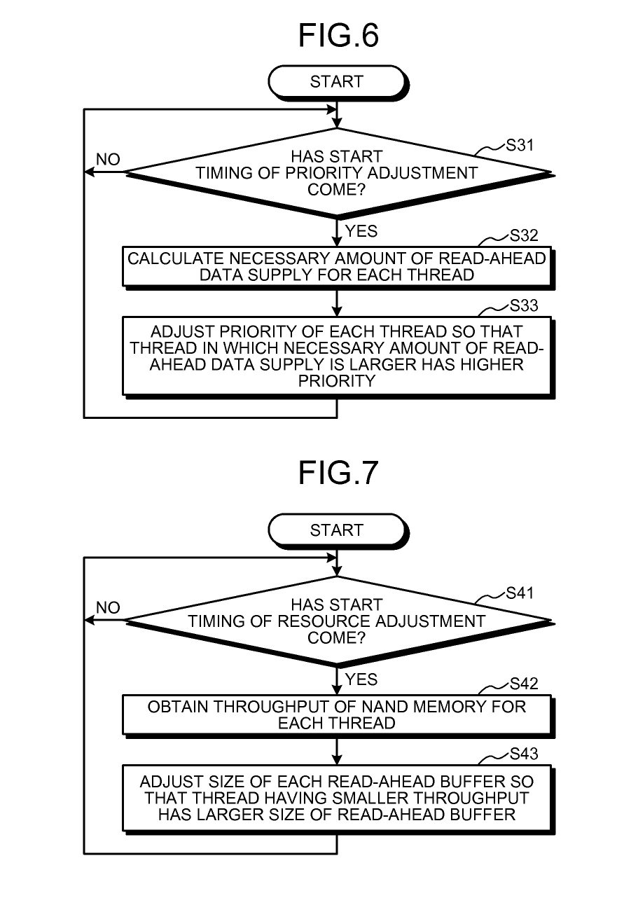

FIG. 6 is a flowchart for explaining an operation of the access management unit 173. The access management unit 173 determines whether a start timing of priority adjustment has come (S31). The start timing of the priority adjustment can be arbitrarily set. For example, the priority adjustment may start at predetermined time intervals. Also, the priority adjustment may start at every time when a predetermined number of commands are received.

When the start timing of the priority adjustment has not come (No in S31), the access management unit 173 performs the processing of S31 again. When the start timing of the priority adjustment has come (Yes in S31), the access management unit 173 calculates a necessary amount of the read-ahead data supply for each thread (S32). The necessary amount of the read-ahead data supply is calculated by subtracting the size of the read-ahead data stored in the read-ahead buffer 19 from the capacity of the read-ahead buffer 19. That is, the necessary amount of the read-ahead data supply is equal to a free space size at the time of performing the processing of S32.

After the processing of S32, the access management unit 173 adjusts the priority of each thread so that the thread in which the necessary amount of the read-ahead data supply is larger has higher priority (S33). For example, when the necessary amount of the read-ahead data supply to the read-ahead buffer 19a is larger than that to the read-ahead buffer 19b, the access management unit 173 adjusts the priority of each thread so that the priority of the thread a becomes higher than that of the thread b. After the processing of S33, the access management unit 173 performs the processing of S31 again.

The priority may be information indicating an order or may be information having a degree of the priority as a numerical number. When the information having the degree of the priority as the numerical number is applied as the information about the priority, the read-ahead unit 171 may calculate an execution frequency of the cluster read for each thread by using a function. The function which defines the relation between the priority and the execution frequency of the cluster read has been previously set.

Also, a total amount of the memory resources included in the read-ahead buffer region 18 may be fixed or may be variable.

In the above description, an example has been described in which the two threads (thread a and thread b) are managed. However, the above description can be applied to a case where equal to or more than three threads are managed. Specifically, the relation between the threads a and b is established between any two threads out of equal to or more than three threads.

In this way, according to the first embodiment, the resource management unit 172 obtains the peak request amount from the host 2 for each thread and adjusts the size of each read-ahead buffer 19 based on the peak request amount obtained for each thread. Specifically, the resource management unit 172 increases the size of the read-ahead buffer 19 for the thread of which the peak request amount from the host 2 is larger. Accordingly, the memory resource of the read-ahead buffer region 18 is allocated to each read-ahead buffer 19 so that an event that the read-ahead data is exhausted when a required amount from the host 2 per unit hour suddenly becomes large can be prevented in any thread as possible. That is, increase in the latency due to the exhaustion of the read-ahead data can be reduced in any thread.

When any one of the plurality of read-ahead buffers included in the read-ahead buffer region 18 has the free region, the read-ahead unit 171 performs the read-ahead until there becomes no free region. Also, when receiving the sequential read command, the read control unit 17 outputs the data buffered in the read-ahead buffer 19 regarding the thread to which the sequential read command belongs to the host 2.

Also, the resource management unit 172 may match a ratio between the size of the read-ahead buffer 19a and that of the read-ahead buffer 19b and a ratio between the peak request amount regarding the thread a and that regarding the thread b. Accordingly, the resource management unit 172 can adjust the size of each read-ahead buffer 19 by a simple calculation.

The resource management unit 172 may use the maximum value of the size information included in the one or more sequential read commands for configuring the thread as an index indicating the peak request amount of the thread. Also, the maximum value of the size information may be selected in a range of a predetermined number of sequential read commands which has been recently received. Accordingly, the resource management unit 172 can easily calculate the peak request amount.

Also, the resource management unit 172 records the total amount of the size of data, which is required to be read in the period of the first time, at the intervals of the first time. The resource management unit 172 may select the maximum value in the period of the latest second time from among the recorded values as the peak request amount. The second time is longer than the first time.

Also, the access management unit 173 obtains the free space size in each read-ahead buffer 19 and determines the priority, which is to be set for each thread, based on each free space size. Specifically, the access management unit 173 adjusts the priority set for each thread so that the thread having the larger free space size in the read-ahead buffer 19 has the higher priority. Even when the free space sizes of the plurality of read-ahead buffers 19 vary, timings to complete the supply of the read-ahead data can be synchronized as possible. Accordingly, variation in the latencies of the sequential reads between the threads can be reduced as possible.

The above description has been made under an assumption that the priority is adjusted based on the comparison between the free space sizes of the respective read-ahead buffers 19. The access management unit 173 converts the free space sizes of the respective read-ahead buffers 19 according to a predetermined calculation and may adjust the priority based on the comparison between the respective values obtained by the conversion. For example, the access management unit 173 may calculate a ratio of the free space sizes relative to the read-ahead buffer 19 for each thread and adjust the priority based on the comparison of the ratio for each thread. For example, when the ratio of the free space size in the read-ahead buffer 19a is larger than the ratio of the free space size in the read-ahead buffer 19b, the access management unit 173 adjusts the priority of each thread so that the priority of the thread a becomes higher than that of the thread b.

The read-ahead unit 171 may switch the read-ahead by using the priority in any way. For example, the read-ahead unit 171 more frequently performs the cluster read regarding the read-ahead to the thread having higher priority. Also, the read-ahead unit 171 allocates longer performing time for the thread with higher priority when the read-ahead is switched by using the time slicing method.

### Second Embodiment

FIG. 7 is a flowchart for explaining an operation of a second embodiment of the resource management unit 172. The resource management unit 172 determines whether the start timing of the resource adjustment has come (S41). The start timing of the resource adjustment can be arbitrarily set, similarly to the first embodiment. When the start timing of the resource adjustment has not come (No in S41), the resource management unit 172 performs the processing of S41 again. When the start timing of the resource adjustment has come (Yes in S41), the resource management unit 172 obtains a throughput of the NAND memory 10 for each thread (S42). The throughput of the NAND memory 10 is an output speed of the read-ahead data from the NAND memory 10.

The resource management unit 172 may measure the throughput for each thread in the processing of S42. Also, the read-ahead unit 171 measures and records the latest throughput for each thread. Then, the resource management unit 172 may obtain the measured value of the throughput for each thread from the read-ahead unit 171.

After the processing of S42, the resource management unit 172 adjusts the size of each read-ahead buffer so that the thread having the smaller throughput has the larger size of the read-ahead buffer 19 (S43). For example, when the throughput regarding the thread a is smaller than that regarding the thread b, the resource management unit 172 adjusts the size of each read-ahead buffer 19 so that the size of the read-ahead buffer 19a becomes larger than that of the read-ahead buffer 19b. A difference or a ratio between the sizes of the respective read-ahead buffers 19 may be fixed and may be variable, for example, according to a difference or a ratio between the respective throughputs.

After the processing of S43, the resource management unit 172 performs the processing of S41 again.

As has been described above, according to the second embodiment, the resource management unit 172 obtains the throughput (the throughput of read-ahead from the NAND memory 10) regarding the read-ahead for each thread and adjusts the size of each read-ahead buffer 19 based on the obtained throughput for each thread. Specifically, the resource management unit 172 increases the size of the read-ahead buffer 19 for the thread having smaller throughput at the time of performing the read-ahead. Since larger read-ahead data is buffered for the thread with a lower supply speed of the read-ahead data, the event that the read-ahead data regarding one thread is exhausted can be prevented even when the sequential read commands regarding the one thread with the lower supply speed of the read-ahead data have been sequentially issued in a short time.

The resource management unit 172 may be configured to adjust the size of each read-ahead buffer 19 based on both the peak request amount for each thread and the throughput for each thread. In this case, for example, the resource management unit 172 calculates an evaluation value for each thread by using a function including the peak request amount and the throughput as variables. According to the function, the relation between the evaluation value and the peak request amount is defined so that the relation between the evaluation value and the peak request amount has positive correlation. Also, according to the function, the relation between the evaluation value and the throughput is defined so that the relation between the evaluation value and the throughput has negative correlation. For example, when the evaluation value regarding the thread a is larger than that regarding the thread b, the resource management unit 172 adjusts the size of each read-ahead buffer 19 so that the size of the read-ahead buffer 19a becomes larger than that of the read-ahead buffer 19b. A difference or a ratio between the sizes of the respective read-ahead buffers 19 may be fixed and may be variable, for example, according to a difference or a ratio between the respective evaluation values.

### Third Embodiment

When the data read by the read-ahead is separated and stored in as many chips 12 as possible among a plurality of chips 12 respectively connected to different channels, the read can be performed in parallel from a number of chips 12. Therefore, the throughput of the NAND memory 10 improves. In a third embodiment, the resource management unit 172 uses the number of channels for operating in parallel as an index indicating the throughput.

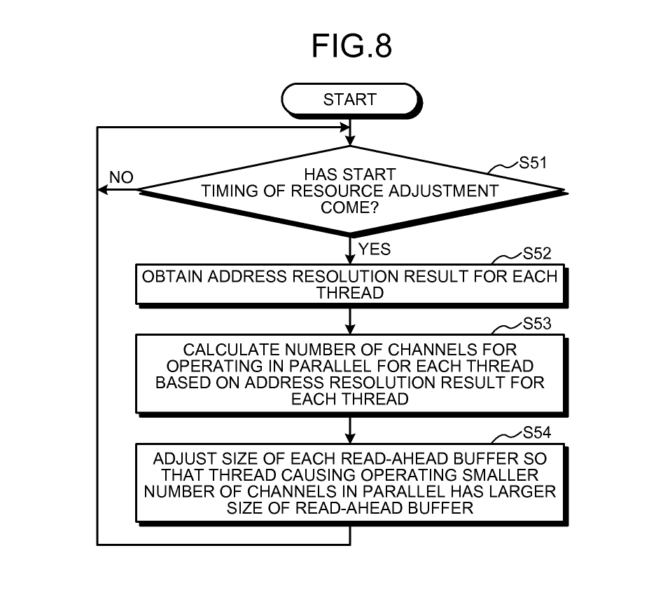

FIG. 8 is a flowchart for explaining an operation of the third embodiment of the resource management unit 172. The resource management unit 172 determines whether the start timing of the resource adjustment has come (S51). The start timing of the resource adjustment can be arbitrarily set, similarly to the first embodiment. When the start timing of the resource adjustment has not come (No in S51), the resource management unit 172 performs the processing of S51 again. When the start timing of the resource adjustment has come (Yes in S51), the resource management unit 172 obtains an address resolution result for each thread (S52).

In the processing of S52, the resource management unit 172 may obtain the address resolution result obtained at the time of the read-ahead in the past. Also, the resource management unit 172 predicts a logical address range to which the read-ahead is performed afterward for each thread and may perform the address resolution to the predicted logical address range.

After the processing of S52, the resource management unit 172 calculates the number of channels, which operate in parallel, for each thread based on the address resolution result for each thread (S53).

For example, the address resolution is performed for each cluster. That is, the physical address of one or more clusters corresponding to the logical address range can be obtained by the address resolution. In the processing of S53, the resource management unit 172 calculates the number of channels necessary for being operated in order to access to all the clusters which are specified by the address resolution.

After the processing of S53, the resource management unit 172 adjusts the size of each read-ahead buffer 19 so that the thread causing operating the smaller number of channels in parallel has the larger size of the read-ahead buffer 19 (S54). After the processing of S54, the resource management unit 172 performs the processing of S51 again.

As has been described above, according to the third embodiment, the resource management unit 172 calculates the number of channels for operating in parallel at the time of the read-ahead and uses the calculated number as the index value indicating the throughput. Specifically, the resource management unit 172 calculates the number of channels for operating in parallel based on the address resolution result regarding the logical address range read with the access pattern of the sequential read. Accordingly, the resource management unit 172 can use the value indicating the size of the throughput without obtaining an actual measured value of the throughput.

A physical address range, which has a size of a plurality of pages and in which each physical addresses are in succession, may be mapped to the memory cell array included in each chip 12 so that the physical address range is separated and distributed to as many chips 12 as possible among the plurality of chips 12 respectively connected to different channels for each page. In this case, when the read is performed in the order of the physical addresses, the number of channels for operating in parallel becomes or becomes close to the maximum value. As a result, the throughput becomes higher. Also, when the read is performed in the order of the physical addresses, since the read-ahead of the plurality of clusters can be performed by one page read relative to the memory cell array, total number of times of the page read necessary for the read-ahead is reduced. As a result, the throughput becomes higher. The resource management unit 172 may use a degree of succession of the physical addresses as the index value indicating the throughput. An arbitrary method can be applied to the method for calculating the degree of the succession of the physical addresses. For example, the succession can be evaluated according to the number of pages in which a series of the data specified by the logical address range of the unit size is separated and stored. When the number of pages of storage destination of the series of the data is small, this indicates that the succession of the physical address is high. That is, the number of pages of the storage destination of the series of the data is smaller, the number of channels for operating in parallel becomes larger. As a result, the throughput becomes larger.

There are causes for having effect on the throughput other than the number of channels for operating in parallel. For example, there is a direct look ahead (DLA) method as a read system of the data from the memory cell array. The DLA method will be described below. At the time of the read from a memory cell, the memory system 1 previously reads data of an adjacent memory call in which the write is performed after the memory cell before the read. The memory system 1 determines a read condition of the memory cell about to be read according to the read result and corrects a threshold of the memory cell to be read. When the read corresponding to the DLA method is performed, the throughput decreases. The resource management unit 172 may estimate the throughput according to the condition whether the read corresponding to the DLA system is performed.

Also, there is a method for storing information of a plurality of bits per a memory cell as a storage system of the data by the memory cell array. Different bits in each memory cell respectively compose different pages. There is a case where a read speed changes according to a condition that data is read from which bit in a single memory cell. The resource management unit 172 can estimate the throughput according to a condition that the read location by the read-ahead is a page configured by which bit in the memory cell.

Also, a bit error rate may be recorded for each predetermined unit size. When a bit error has occurred, the read-ahead unit 171 corrects the error. That is, the higher the bit error rate is, the slower the read speed is. The resource management unit 172 may estimate the throughput based on the bit error rate of the read location by the read-ahead.

### Fourth Embodiment

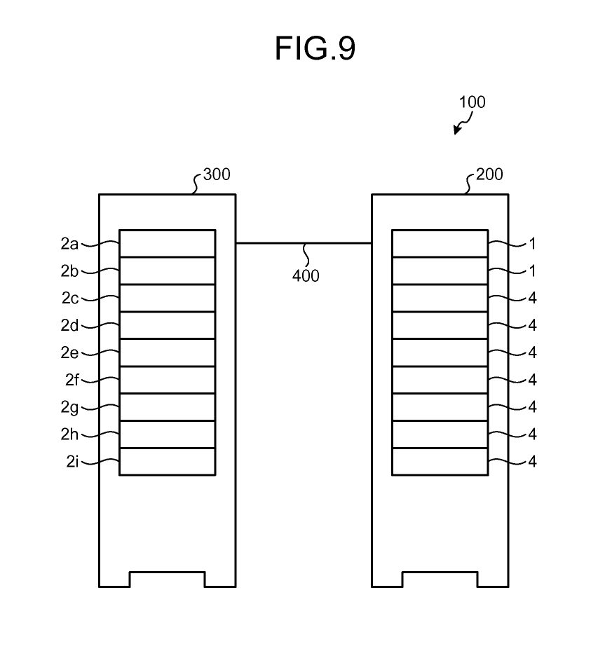

FIG. 9 is a diagram of an exemplary implementation of a memory system 1. The memory system 1 is implemented, for example, to a server system 100. The server system 100 includes a disk array 200 and a rack mount server 300. The disk array 200 is connected to the rack mount server 300 by a communication interface 400. An arbitrary standard can be employed as a standard of the communication interface 400. The rack mount server 300 includes one or more hosts 2 (a host 2a to a host 2i) mounted on a server rack. The hosts 2a to 2i can access to the disk array 200 via the communication interface 400.

Also, the disk array 200 is configured to include one or more memory systems 1 and one or more hard disk units 4 mounted on the server rack. Each memory system 1 can perform read commands from the hosts 2a to 2i. Also, each memory system 1 has a configuration in which the first to third embodiments are employed. Accordingly, even when the plurality of hosts 2a to 2i respectively requires the sequential read, occurrence of the exhaustion of the read-ahead data in the respective hosts 2a to 2i can be prevented. Therefore, increase in the latency of the sequential read of each thread can be efficiently reduced.

In the disk array 200, for example, one or more memory systems 1 may be used as a cache of one or more hard disk units. In the disk array 200, a storage controller unit for building a RAID may be mounted on one or more hard disk units 4.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile memory;
a read control unit configured to perform a sequential read of two threads from the non-volatile memory;
a read-ahead unit configured to perform read-ahead to the non-volatile memory for each thread;
a buffer memory configured to include two read-ahead buffers, the respective read-ahead buffers holding data which is read-ahead from the non-volatile memory, the data held by the respective read-ahead buffers belonging to threads different from each other; and
a resource management unit configured to obtain a peak request amount from outside for each thread and adjust a size of each read-ahead buffer based on the obtained peak request amount for each thread.

2. The memory system according to claim 1, wherein,
in a case where one of the two read-ahead buffers has a free space, the read-ahead unit performs the read-ahead until there becomes no free space in the one read-ahead buffers.

3. The memory system according to claim 1, wherein,
at the time of receiving a read command for specifying a logical address range in which data has been read-ahead already, the read control unit outputs data held by one of the two read-ahead buffers for a thread to which the read command belongs to the outside.

4. The memory system according to claim 1, wherein
the resource management unit, in a case where a peak request amount by a first thread is larger than a peak request amount by a second thread, adjusts a size of a first read-ahead buffer which is a read-ahead buffer for the first thread to become larger than a size of a second read-ahead buffer which is a read-ahead buffer for the second thread.

5. The memory system according to claim 1, wherein
the memory system receives a plurality of read commands respectively including size information, and the resource management unit selects the maximum value of the size information included in the received read commands as the peak request amount.

6. The memory system according to claim 1, wherein
the resource management unit calculates a plurality of total read amounts for every first time period during a second time period and selects a maximum value among the plurality of calculated total read amounts as the peak request amount, and the first time period is shorter than the second time period.

7. The memory system according to claim 1, wherein
the resource management unit obtains an index value indicating a throughput of the non-volatile memory for each thread and adjusts the size of each read-ahead buffer based on each index value.

8. The memory system according to claim 7, wherein
the resource management unit calculates for each thread an evaluation value in which relation between the evaluation value and the peak request amount has positive correlation and relation between the evaluation value and the index value has negative correlation, wherein
the resource management unit, in a case where the evaluation value for a first thread is larger than the evaluation value for a second thread, adjusts a size of a first read-ahead buffer which is a read-ahead buffer for the first thread to become larger than a size of a second read-ahead buffer which is a read-ahead buffer for the second thread.

9. The memory system according to claim 7, wherein
the resource management unit measures the throughput and uses a measured value of the throughput as the index value.

10. The memory system according to claim 7, wherein
the non-volatile memory includes a plurality of memory chips, each memory chip is connected to a different channel among a plurality of channels capable of operating in parallel to each other, and the resource management unit calculates the number of channels for operating in parallel at the time of read-ahead among the plurality of channels and uses the calculated number as the index value.

11. The memory system according to claim 1, further comprising:
an access management unit configured to obtain a free space size of each read-ahead buffer and determines a priority for each thread based on each free space size, wherein
the read-ahead unit switches performance of the read-ahead for each thread based on the priority.

12. The memory system according to claim 11, wherein
the read-ahead unit more frequently performs read processing for a first thread than that for a second thread, the read processing is to read data of unit size from the non-volatile memory, and the priority of the first thread is higher than that of the second thread.

13. The memory system according to claim 11, wherein
the read-ahead unit switches the performance of the read-ahead for each thread by using a time slicing method and allocates longer performing time to the read-ahead for the first thread than to the read-ahead for the second thread, and
the priority of the first thread is higher than that of the second thread.

14. A memory system comprising:
a non-volatile memory;
a read control unit configured to perform a sequential read of two threads;
a read-ahead unit configured to perform read-ahead relative to the non-volatile memory for each thread;
a buffer memory configured to include two read-ahead buffers, the respective read-ahead buffers holding data which is read-ahead from the non-volatile memory, the data held by the respective read-ahead buffers belonging to threads different from each other; and
a resource management unit configured to obtain an index value indicating a throughput of the non-volatile memory for each thread and adjust a size of each read-ahead buffer based on each index value.

15. The memory system according to claim 14, wherein
the resource management unit, in a case where a throughput for a first thread is smaller than that for a second thread, adjusts a size of a first read-ahead buffer which is a read-ahead buffer for the first thread to become larger than a size of a second read-ahead buffer which is a read-ahead buffer for the second thread.

16. The memory system according to claim 14, wherein
the resource management unit measures the throughput and uses a measured value of the throughput as the index value.

17. The memory system according to claim 14, wherein
the non-volatile memory includes a plurality of memory chips, each memory chip is connected to a different channel among a plurality of channels capable of operating in parallel to each other, and the resource management unit calculates the number of channels for operating in parallel at the time of read-ahead among the plurality of channels and uses the calculated number as the index value.

18. A memory system comprising:
a non-volatile memory;
a read control unit configured to perform a sequential read of two threads;
a read-ahead unit configured to perform read-ahead relative to the non-volatile memory for each thread;
a buffer memory configured to include two read-ahead buffers, the respective read-ahead buffers holding data which is read-ahead from the non-volatile memory, the data held by the respective read-ahead buffers belonging to threads different from each other; and
an access management unit configured to obtain a free space size of each read-ahead buffer and determine a priority set for each thread based on each free space size, wherein
the read-ahead unit switches the performance of the read-ahead for each thread based on the priority.

19. The memory system according to claim 18, wherein
the read-ahead unit more frequently performs read processing for a first thread than that for a second thread, the read processing is to read data of unit size from the non-volatile memory, and priority of the first thread is higher than that of the second thread.

20. The memory system according to claim 18, wherein
the read-ahead unit switches the performance of the read-ahead for each thread by using a time slicing method and allocates longer performing time to the read-ahead for the first thread than to the read-ahead for the second thread, and the priority of the first thread is higher than that of the second thread.

21. A memory system comprising:
a non-volatile memory;
a read unit configured to perform a sequential read of two threads from the non-volatile memory;
two buffers, each belonging to a different one of the two threads; and
a management unit configured to adjust the sequential read by each thread.
